(19) United States
(12) Patent Application Publication
(10) Pub. No.: US 2016/0253475 A1
(43) Pub. Date: Sep. 1, 2016

(54) COMPLIMENTARY TRADE DRUG DELIVERY SYSTEM

(71) Applicant: MERCK SHARP & DOHME CORP., Rahway, NJ (US)

(72) Inventor: Kevin Scott PARIS, Lansdale, PA (US)

(73) Assignee: MERCK SHARP & DOHME CORP., Rahway, NJ (US)

(21) Appl. No.: 15/032,848

(22) PCT Filed: Oct. 30, 2014
(86) PCT No.: PCT/US2014/063061

§ 371 Date: Apr. 28, 2016

Related U.S. Application Data
(60) Provisional application No. 61/898,230, filed on Oct. 31, 2013.

(51) Int. Cl. G06F 19/00

(52) U.S. Cl. CPC G06F 19/3456; G06F 19/328

(57) ABSTRACT

A complimentary trade drug delivery system comprising (a) an electronic health record platform for storing patient health record data and generating electronic prescriptions, and (b) an eligibility verification system for identifying and verifying eligible programs, patients and health care providers for complimentary trade drug programs. The eligibility verification system automatically verifies that patients and prescribing health care providers are eligible to participate in existing complimentary trade drug programs and sends orders to program pharmacy computer systems that cause a program pharmacy computer system to deliver complimentary trade drugs to a patient. The complimentary trade drug system automatically receives an electronic prescription for a prescribed drug, identifies a complimentary trade drug program for the prescribed drug, the complimentary trade drug program including a program drug, generates an order for the electronic prescription, the order including complimentary units of the program drug, and transmits the order over an electronic communications channel to a prescription routing system for the program pharmacy computer system, thereby causing the program pharmacy computer system to send a complimentary unit of the program drug to the patient.

### TECHNICAL FIELD

The present invention relates generally to complimentary trade drug processing, and more particularly to systems and methods for automatically verifying and distributing complimentary trade drug units to patients using a data communications network.

### BACKGROUND

The Prescription Drug Marketing Act of 1987 (PDMA) was enacted (1) to ensure that drug products purchased by consumers are safe and effective, and (2) to avoid exposing American consumers to danger and physical harm arising from counterfeit, adulterated, misbranded, subpotent, or expired drugs. The legislation was deemed necessary to increase safeguards in the drug distribution system and to prevent the introduction and retail sale of substandard, ineffective or counterfeit drugs. Under certain provisions of the PDMA, pharmaceutical drug manufacturers are permitted to market and promote pharmaceutical drugs by distributing free samples to health care providers (HCPs), who are encouraged to provide the free samples to their patients when the HCPs write prescriptions for the pharmaceutical drugs being promoted. This method of promoting pharmaceutical drugs by providing free samples for patients to use on a trial basis has been described as serving dual purposes of (1) increasing consumer awareness of and experience with the promoted drugs, and (2) helping to reduce the incidence of patients failing to adhere to prescription medication treatment plans.

However, as will be described below, there are a number significant problems associated such promotional programs, and these problems have so far resulted in limited adoption and success rates. One of the disadvantages relates to how the samples are distributed to the HCPs. In a typical scenario, getting the trial medication into the hands of patients involves a lengthy and inefficient series of actions that must be coordinated and carried out manually by a relatively large number of people associated with the trial medication supply chain. The process usually includes, for example, all of the following actions:
1. The sales representative uses a laptop computer system to submit a request for a sample order of the promoted pharmaceutical drug.
2. A sampling operations department operated by the pharmaceutical manufacturer processes the sales representative's sample order request.
3. The sample order request is passed to third party logistics vendor.
4. The third party logistics vendor picks and packages the sample order in a warehouse and ships the order to the sales representative via line haul carrier to a market city local carrier.
5. The market city local carrier receives the order and informs the sales representative.
6. The sales representative and the market city local carrier schedule a meeting to exchange the sample order.
7. The market city local carrier delivers the sample order to the sales representative at the scheduled meeting time and place.
8. The sales representative completes compliance documents and verifies the shipment for accuracy.
9. A pharmaceutical sales representative identifies a health care provider (HCP) that might be willing to store and distribute free samples of the promoted pharmaceutical drug.
10. The sales representative schedules an appointment with the HCP.
11. The sales representative meets with the HCP to discuss the trial medication and confirm that the HCP is willing to store and distribute the trial medication free samples.
12. The HCP signs a sample order request and the sales representative provides the free samples to the HCP.
13. The free samples are stored in a closet in the HCP's office.
14. The HCP provides free samples of the promotional pharmaceutical drug to the patient along with a prescription.

The above-described process is fraught with potential problems, including significant wait times when everything goes just right, as well as extended delays and waste caused by human error, conflicting schedules, transportation problems, mistakes in material handling, inventory record-keeping, data-entry problems, over processing, over production and discards.

### DISCLOSURE OF THE INVENTION

Embodiments of the present invention address the above-described problems associated with distributing trial medications by providing a computer-implemented method and an apparatus for distributing a complimentary trade drug to a patient. In one aspect of the invention, there is provided a method for distributing complimentary trade drugs using a complimentary trade drug delivery system, comprising: (a) receiving an electronic prescription for a prescribed drug on the complimentary trade drug delivery system; (b) identifying a complimentary trade drug program for the prescribed drug, the complimentary trade drug program including a program drug; (c) generating an order on the complimentary trade drug delivery system to deliver the program drug in the complimentary trade drug program to the patient; (d) establishing on the complimentary trade drug delivery system an electronic communications channel with a prescription routing system, the prescription routing system being configured to cause a program pharmacy computer system to deliver one or more units of the program drug to patients; and (e) transmitting the order over the electronic communications channel, the order causing the program pharmacy computer system to send the program drug to the patient.

In some embodiments of the present invention, the method includes providing a set of patient eligibility rules for the identified complimentary trade drug program on the complimentary trade drug delivery system; and determining on the complimentary trade drug delivery system that the patient is eligible for the identified complimentary trade drug program based on the set of patient eligibility rules. The method may also include the steps of providing on the complimentary trade drug delivery system a set of health care provider eligibility rules for the identified complimentary trade drug program; receiving a health care provider identifier with the electronic prescription; determining that the health care provider is eligible for the identified complimentary trade drug program based on the set of health care provider eligibility rules. The method may further include the steps of determining that the patient is eligible to receive an enhanced offer with the identified complimentary trade drug program and changing the order to incorporate the benefits of the enhanced offer.

The method may also include the optional steps of receiving a consent indicator confirming that the patient consents to participating in the identified complimentary trade drug program for the prescribed drug and receiving an acknowledgment from the program pharmacy computer system that the complimentary trade drug has been sent to the patient.

In some embodiments of the present invention, the program drug is not the prescribed drug. In these cases, the method may include determining that the prescribed drug is associated with a particular drug family and identifying the existing complimentary trade drug program based on the association with the particular drug family. Additionally, the method may include receiving a diagnosis for the patient with the electronic prescription and identifying an existing complimentary trade drug program based on the diagnosis.

According to another aspect of the invention, there is provided a complimentary trade drug delivery system for distributing a complimentary trade drug to a patient. The system includes an electronic health record (EHR) platform, an eligibility verification system (EVS) and an electronic communications channel. The EHR platform is used by a HCP to generate an electronic prescription (eRx) for a patient, the electronic prescription including a patient identifier and a prescribed drug. As will be described in more detail below, the EVS carries out a number of eligibility checks, based on information contained in the eRx, and, in accordance with the outcomes of the eligibility checks, sends orders and eligibility indicators to the EHR platform. The EHR platform then uses the electronic communications channel to transmit orders to a prescription routing system, which causes a pharmacy participating in the complementary trade drug program to send the program drug to the patient.

Under certain circumstances, such as when the patient is not eligible to participate in a complimentary trade drug program, the EVS and EHR platform operate together so as to cause the EHR platform to use the electronic communications channel to transmit an order and the eRx to the prescription routing system, wherein the order will be filled by a non-program pharmacy. Orders transmitted by the EHR platform to the prescription routing system result in one or more units of the complimentary trade drug being sent to the patient without charge to the patient (i.e., the patient receives a limited number of units of the program drug to use for free on a trial basis). But orders transmitted by the EHR platform to the prescription routing system typically result in a non-program pharmacy computer system fulfilling the eRx in the conventional manner used by conventional retail and mail-order pharmacies, whereby the patient will be charged for the medications in the prescription.

The EVS includes a network interface, a microprocessor, one or more computer programs, one or more databases and a collection of business rules (a.k.a. business logic) combined and arranged so as to enable the EVS to receive an eRx from the EHR platform, identify a complimentary trade drug program for the drug prescribed in the eRx, and check and verify the eligibility statuses of the patient and the HCP in the eRx.

The one or more computer programs includes a computer program, function call, subroutine or module, referred to herein as a program eligibility checker, having program instructions that, when executed by the microprocessor, cause the microprocessor to identify an existing complimentary trade drug program for the prescribed drug in an electronic prescription. The one or more computer programs also includes another computer program, function call, subroutine or module, referred to herein as an order generator, having program instructions that, when executed by the microprocessor, will cause the microprocessor to generate an order for the EHR platform. When the order generated by the order generator is sent by the EHR platform to a program pharmacy in the prescription routing system, it will cause the program pharmacy to send the patient a complimentary trade drug at no cost to the patient in accordance with the terms of the identified complimentary trade drug program.

In preferred embodiments, the one or more computer programs on the EVS further includes a patient eligibility checker, a HCP eligibility checker, an insurance status checker, and a formulary status checker. The patient eligibility checker includes program instructions that, when executed by the microprocessor, cause the microprocessor to determine that the patient is eligible for the identified complimentary trade drug program. The HCP eligibility checker includes program instructions that, when executed by the microprocessor, cause the microprocessor to determine that the health care provider is eligible for the identified complimentary trade drug program. The insurance status checker and formulary status checker have program instructions that, when executed by the microprocessor, cause the microprocessor to determine that the patient is eligible to receive an offer for the complimentary trade drug under his or her insurance policy and/or eligible to receive an enhanced offer for the complimentary trade drug under the complimentary trade drug program. As will be described in more detail below, the EVS may also include other computer programs, function calls, subroutines or modules that check, for example, concomitant interactions associated with the program drugs, as well as matches between program drugs and patient conditions.

In preferred embodiments, the one or more computer programs on the EVS are programmed to determine eligibility statuses and generate orders in accordance with rules and logic stored in the collection of business rules on the EVS, as well as patient data, HCP data, complimentary trade drug data, alternative drug data, and insurance and formulary data stored in the one or more databases associated with the EVS.

As previously stated, the prescribed drug may be different from the program drug in a complimentary trade drug program. In this case, the program eligibility checker may further include program instructions that, when executed by the microprocessor will cause the microprocessor to determine that the prescribed drug is associated with a particular drug family and to identify the existing complimentary trade drug program based on the prescribed drug's association with the particular drug family. Additionally, the program eligibility checker may include instructions that, when executed by the microprocessor, will cause the microprocessor to identify the existing complimentary trade drug program based on the diagnosis in the eRx.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 shows a high-level block diagram of a computer network configured to operate according to an embodiment of the present invention;

FIG. 2 is a UML sequence diagram illustrating an example of the sequence of messages that may be communicated electronically in an embodiment of the present invention;

FIG. 3 is an example of an electronic prescription (eRx) record according to an embodiment of the present invention;

FIGS. 4A and 4B show examples of orders that might be generated by the eligibility verification system (EVS) in accordance with some embodiments of the present invention;

FIG. 5 is a flow diagram illustrating by way of example the steps that may be performed by a computer system or a network of computer systems configured to distribute a complimentary trade drug to a patient according to an embodiment of the present invention;

FIG. 6 is a flow diagram illustrating by way of example the steps that may be performed by a computer system or a network of computer systems configured to determine whether a complimentary trade drug program exists for a prescribed drug according to an embodiment of the present invention;

FIG. 7 is a flow diagram illustrating by way of example the steps that may be performed by a computer system or a network of computer systems configured to determine whether a patient is eligible for the complimentary trade drug program according to an embodiment of the present invention;

FIG. 8 is a flow diagram illustrating by way of example the steps that may be performed by a computer system or a network of computer systems configured to determine whether a health care provider is eligible for the complimentary trade drug program according to an embodiment of the present invention;

FIG. 9 is a flow diagram illustrating by way of example the steps that may be performed by a computer system or a network of computer systems configured to determine whether a patient is eligible to receive an enhanced offer for a complimentary trade drug according to an embodiment of the present invention.

### BEST MODE FOR CARRYING OUT THE INVENTION

### The Exemplary Computing Network

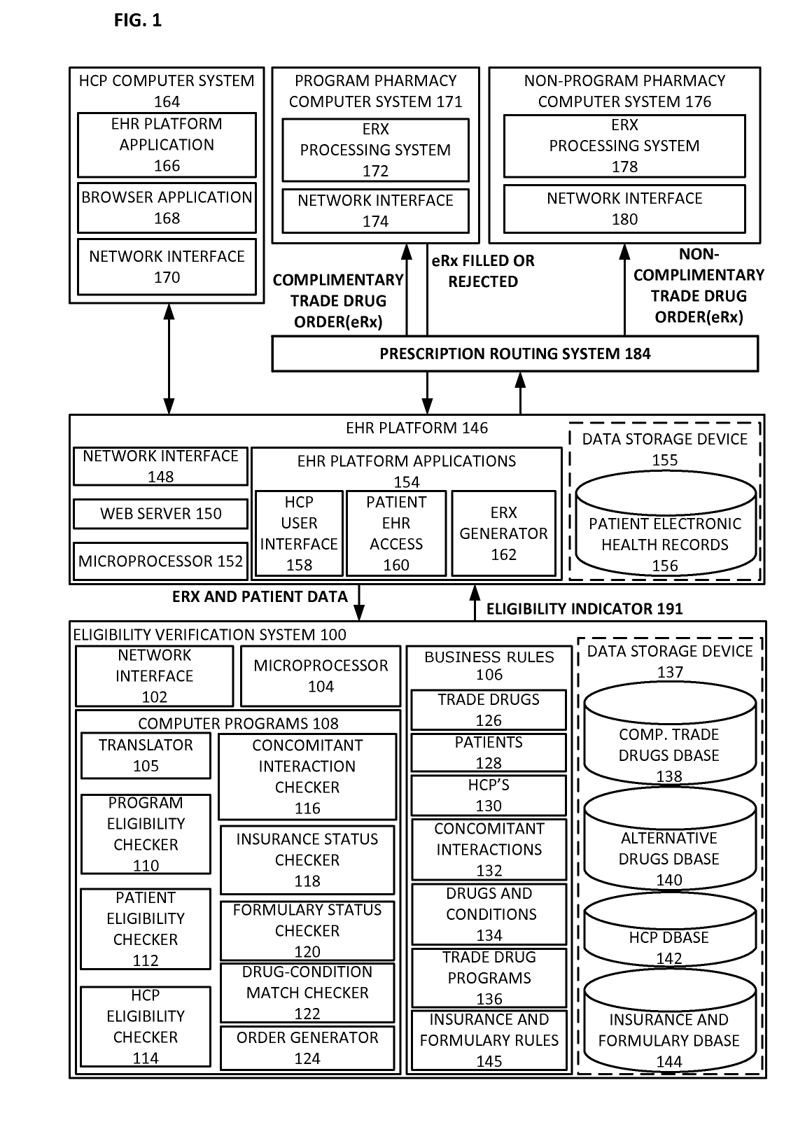

FIG. 1 shows an example of computer network for distributing a complimentary trade drug to a patient in accordance with some embodiments of the invention. The computer network includes an eligibility verification system (“EVS”) 100, an electronic health record (“EHR”) platform 146, a health care provider (“HCP”) computer system 164, a prescription routing system 184, a program pharmacy computer system 171 and a “non-program” pharmacy computer system 176.

Eligibility Verification System 100

As illustrated in FIG. 1, an exemplary eligibility verification system (“EVS”) 100 for distributing a complimentary trade drug to a patient according to one embodiment of the present invention includes a network interface 102, a microprocessor 104, computer programs 108 comprising a collection of software modules 105, 110, 112, 114, 116, 118, 120, 122 and 124, and a set of business rules 106 comprising business rules 126, 128, 130, 132, 134, 136 and 145. The EVS 100 also includes a data storage device 137, which comprises a plurality of files and/or databases 138, 140, 142, and 144. As processing is performed in the EVS, outputs, such as, for example, an eligibility indicator 191 may be provided to EHR platform 146. The network interface 102 is provided to establish electronic communication with the EHR platform 146. The network interface 102 may also provide connectivity to remote terminals and remote computer systems (not shown) operated by users who wish to control access and use the EVS 100.

The EVS 100 can be any general purpose, programmable digital computing device including, for example, a personal computer, a programmable logic controller, a distributed control system, or other computing device. The EVS 100 can include a central processing unit (CPU) or microprocessor, random access memory (RAM), non-volatile secondary storage (e.g., a hard drive, a floppy drive, and a CD-ROM drive), and network interfaces (e.g., a wired or wireless Ethernet card and a digital and/or analog input/output card). Program instructions, such as the instructions in computer programs 108, and program data, such as the data in business rules 106, can be loaded into the RAM from the non-volatile secondary storage and provided to the microprocessor 104 for execution. The microprocessor 104 can generate and store results on the data storage device 137 for subsequent access, display, output and/or transmission by and to other computer systems and computer programs.

The collection of computer programs 108, which may comprise multiple firmware or software modules, discussed hereinafter, contain program instructions that cause the microprocessor 104 to perform a variety of specific tasks required to extract, parse, index and tag data contained in the databases stored on data storage device 137 in accordance with business rules or logic stored in business rules 106. Additionally, the program instructions cause the microprocessor 104 to store data on data storage device 137. These software modules are flexible, and may be configured to use a large variety of different business rules, including without limitation, business rules for complimentary trade drugs 126, patients 128, HCPs 130, concomitant interactions 132, drugs and conditions 134, trade drug programs 136 and insurance and formulary rules 145. The purpose and function of each one of the computer software modules in the computer programs 108 will now be described in more detail below.

Translator 105

The Eligibility Verification System 100, includes a Translator Module 105 that interfaces with one or more EHR platforms. For ease of comprehension, only one EHR platform 146 is shown in FIG. 1. It shall be understood by those skilled in the art, however, that the EVS 100 may be configured to communicate with multiple EHR platforms operated by multiple operators. Each of the EHR platforms 146 are operated by software companies operating in the health information technology (HIT) sector of the market. These platforms have all been developed with unique software designs and unique data structures. The operating codes are all different and they have been developed using various computer software languages. The translator 105 receives data from these external platforms and converts the data into a standardized data format which allows the EVS 100 to process the data. Once the functions of the EVS 100 are completed, the EVS 100 passes the results back to the one or more EHR platforms 146 via the Translator 105 and network interface 102.

Program Eligibility Checker 110

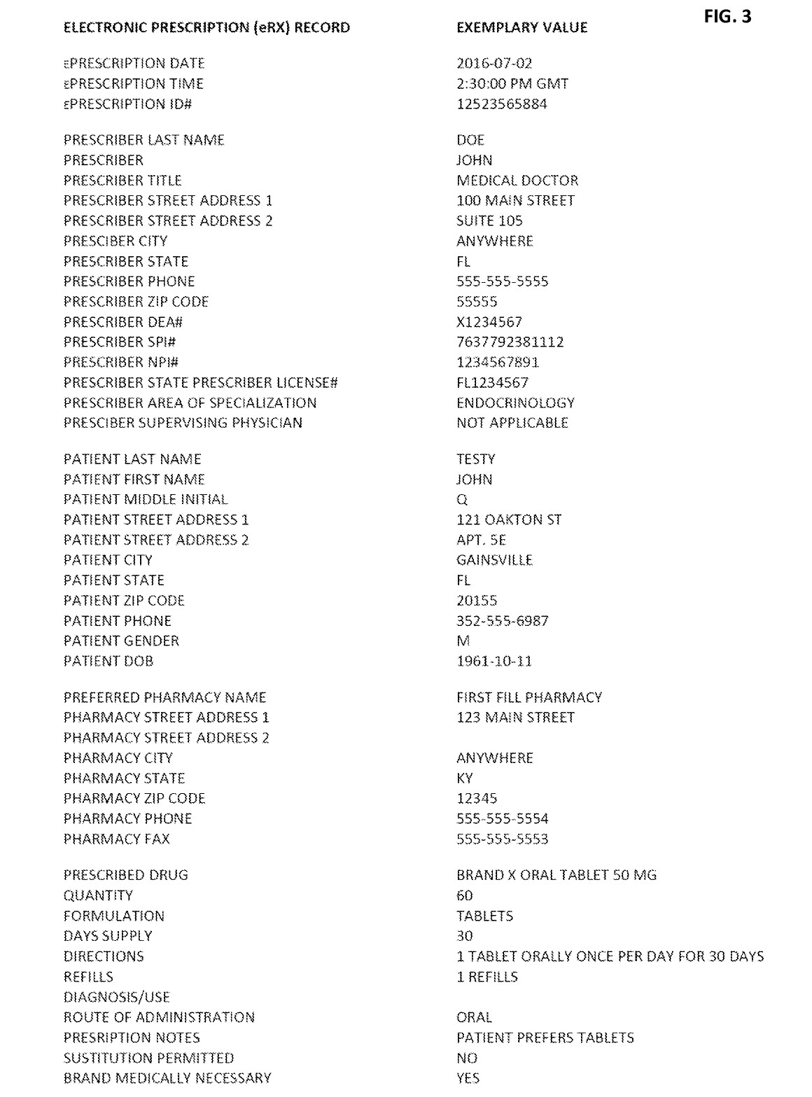

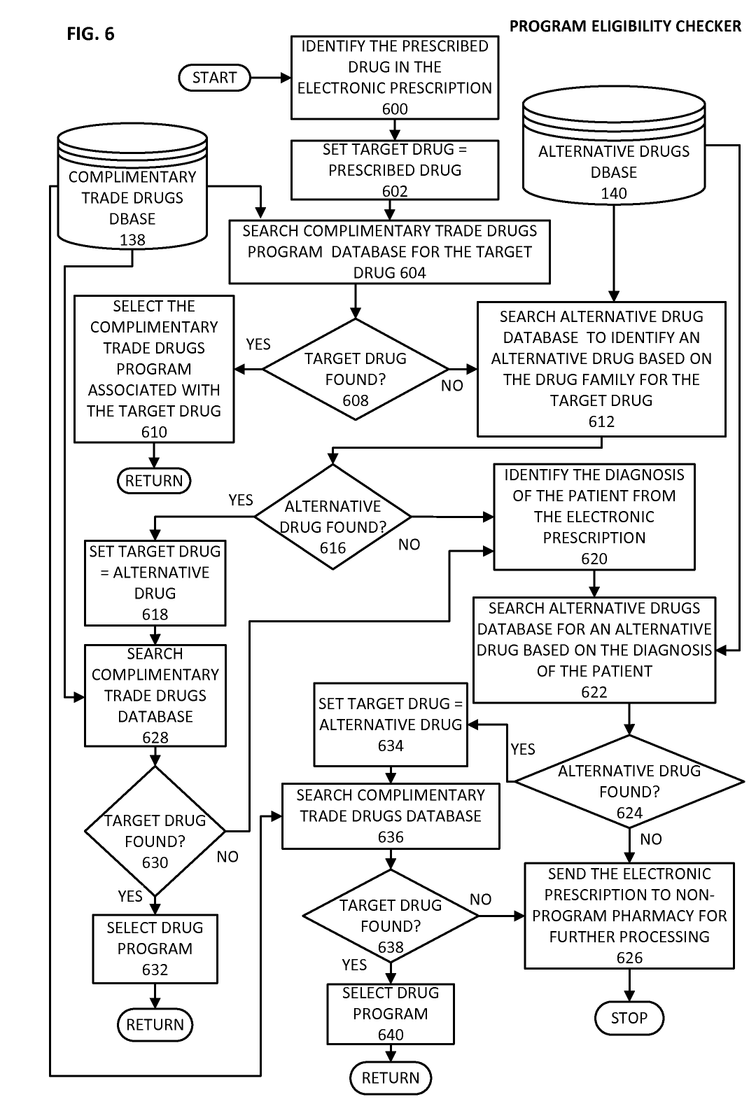

The program eligibility checker 110 in the collection of computer programs 108 contains instructions that, when executed by microprocessor 104, cause the microprocessor 104 to determine whether a complimentary trade drug program exists for the prescribed drug associated with an electronic prescription (eRx) received from the HER platform 146 via network interface 102. A complimentary trade drug program is a program offered to a patient to receive a limited supply of certain trade drugs. The program eligibility checker module 110 receives an electronic prescription (eRx) from the EHR platform 146 and parses the contents of the electronic prescription (eRx) to identify the prescribed drug in the prescription. The extracted content from the electronic prescription may be stored on the data storage device 137. The program eligibility checker 110 then uses the prescribed drug to identify a suitable complementary trade drug program for the electronic prescription (eRx). An illustration of the steps typically performed by the program eligibility checker 110 according to an embodiment of the invention is provided in FIG. 6. An example of the fields and data values typically included in an electronic prescription (eRx) record is shown in FIG. 3. The electronic prescription (eRx) record, as illustrated in FIG. 3, may include information, such as, for example, “prescriber name”, “prescriber address”, “patient name”, “patient address”, “prescribed drug”, “quantity”, “directions”, “diagnosis”, “substitution permitted”, “brand medically necessary”, etc.

Patient Eligibility Checker 112

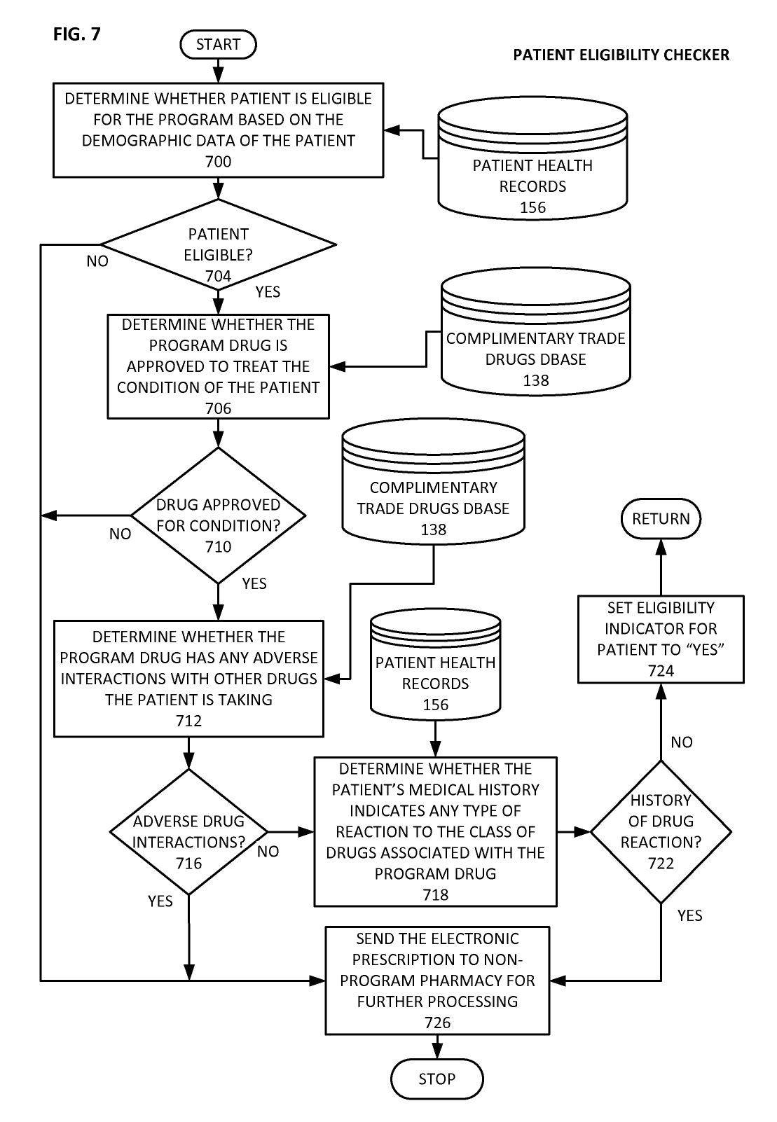

The patient eligibility checker module 112 receives patient data stored in a patient's health record from the EHR platform 146. The patient eligibility checker 112 reads and extracts the contents of the patient's health record to identify certain data associated with the patient, such as, for example, patient's age, gender, state of residence, payor information, medical history, other drugs currently taken by the patient, etc. The extracted content may be stored on data storage device 137. Patient business rules 128 are used to process the extracted content. The patient eligibility checker 112 in the collection of computer programs 108 contains instructions that, when executed by microprocessor 104, cause the microprocessor 104 to determine whether the patient identified in the eRx is eligible for an identified complimentary trade drug program. An illustration of the steps that may be performed by the patient eligibility checker 112 according to an embodiment of the invention is provided in FIG. 7.

HCP Eligibility Checker 114

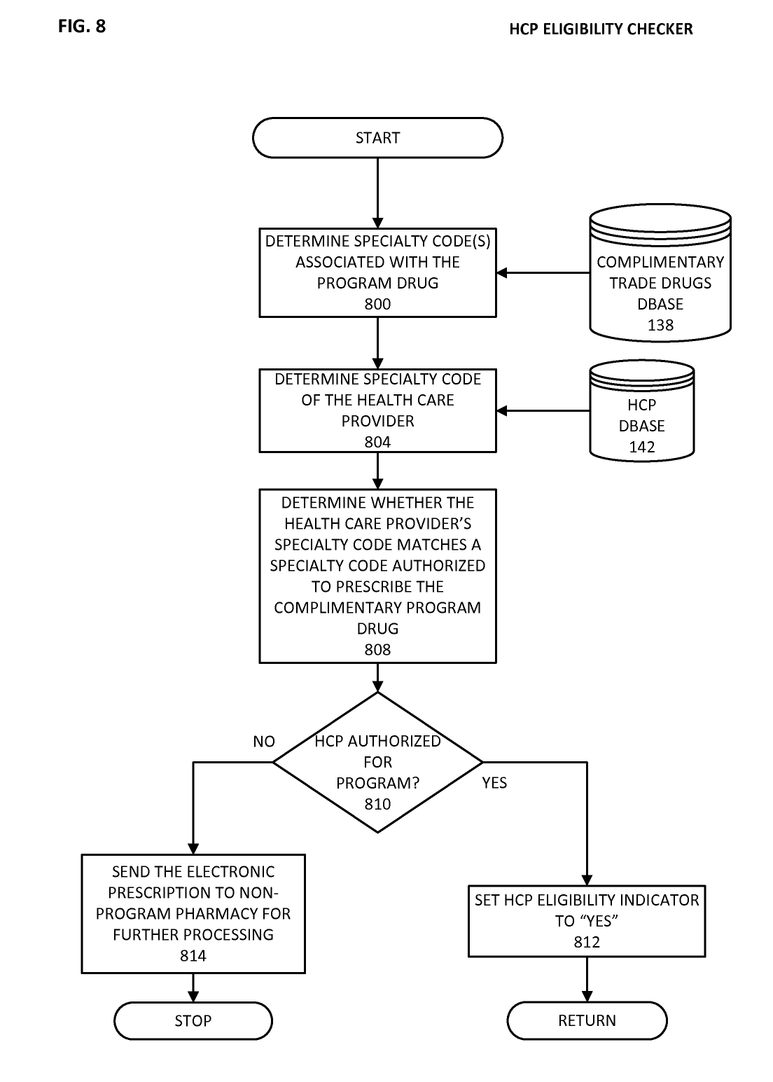

HCP eligibility checker module 114 extracts content from complimentary trade drugs database 138 and HCP database 142 for processing. The content extracted from the complimentary trade drugs database 138 may include information, such as, for example, specialty code(s) associated with a trade drug. The content extracted from the HCP database 142 may include information, such as, for example, specialty code(s) associated with the health care provider. Trade drugs business rules 126 and HCP business rules 130 are used to process the extracted content. The HCP eligibility checker 114 in the collection of computer programs 108 contains instructions that, when executed by microprocessor 104, cause the microprocessor 104 to determine whether a HCP is authorized to prescribe a program trade drug for an identified complimentary trade drug program. An illustration of the steps performed by the HCP eligibility checker 114 in order to accomplish this task according to an embodiment of the invention is provided in FIG. 8.

Concomitant Interactions Checker 116

The concomitant interactions checker 116 in the collection of computer programs 108 contains instructions that, when executed by microprocessor 104, causes the microprocessor 104 to determine whether the patient may have an adverse reaction to the class of drugs associated with the program drug in the complimentary trade drug program identified by the program eligibility checker 110. To carry out this function, the concomitant interactions checker module 116 receives patient data from the EHR platform 146, such as, for example, patient's medical history, including information about the patient previously experiencing an adverse reaction to a particular drug. Additionally, concomitant interactions checker 116 may be configured to extract interaction data from complimentary trade drugs database 138 and the concomitant interactions business rules 132. FIG. 7 contains the steps typically performed by the concomitant interactions checker 116 according to one embodiment of the invention.

Insurance Status Checker 118 and Formulary Status Checker 120

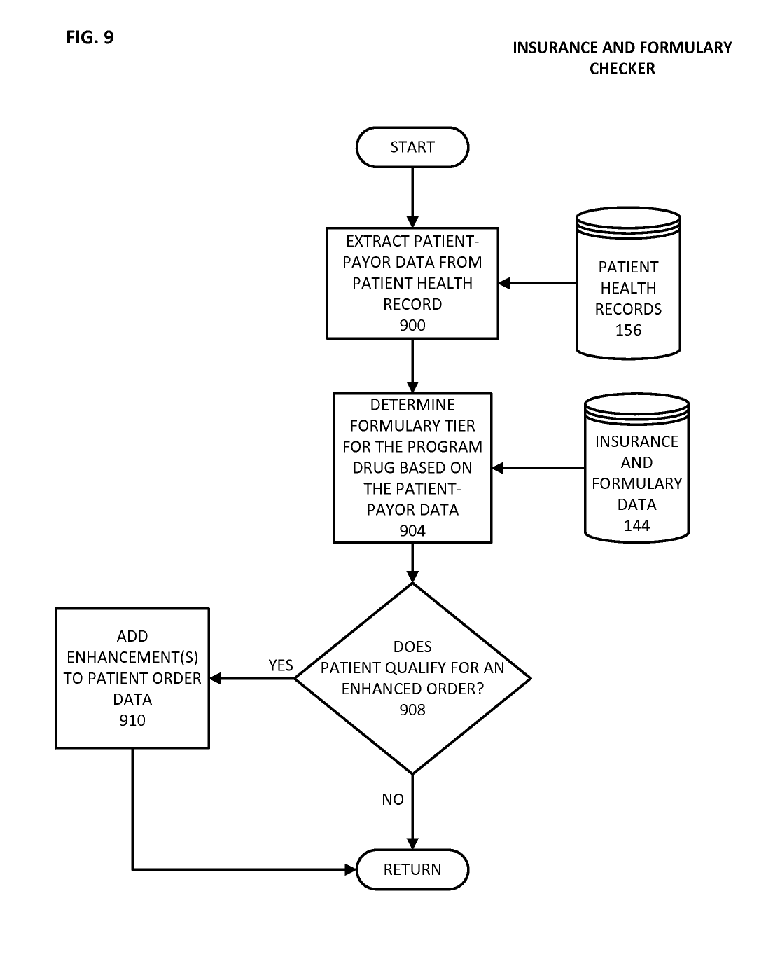

The insurance status checker 118 and formulary status checker 120 modules in the collection of computer programs 108 contain instructions that, when executed by microprocessor 104, cause the microprocessor 104 to determine whether the patient qualifies for an enhanced offer under the complimentary trade drug program. In order to carry out this function, the insurance status checker module 118 may extract insurance status data from insurance and formulary database 144, such as, for example, whether the patient is insured, the insurer's name, etc. A formulary status checker module 120 obtains formulary data from the insurance and formulary database 144, such as, for example the tier status of the program drug. Insurance and formulary business rules 145 are used to process the insurance status and formulary data. FIG. 9 contains a flow diagram illustrating by way of example the steps that may be performed by the insurance status checker 118 and formulary status checker 120 modules according to one embodiment of the invention.

Drug-Condition Match Checker 122

The drug-condition match checker 122 in the collection of computer programs 108 contain instructions that, when executed by microprocessor 104, cause the microprocessor 104 to determine whether the program drug for a complimentary trade drug program identified by the program eligibility checker 110 is approved for a patient's condition. To carry out this function, the drug-condition match checker 122 may be configured to extract program drug data from the complimentary trade drug database 138, such as, for example, program drug approval data, and to receive patient data from EHR platform 146, such as, for example, the patient's current condition (i.e., diagnosis) and medical history. The drugs and conditions business rules 134 may be used to process the data in order to complete the function. The flow diagram in FIG. 7 contains some of the steps that may be performed by the drug condition match checker 122 according to one embodiment of the invention.

Order Generator 124

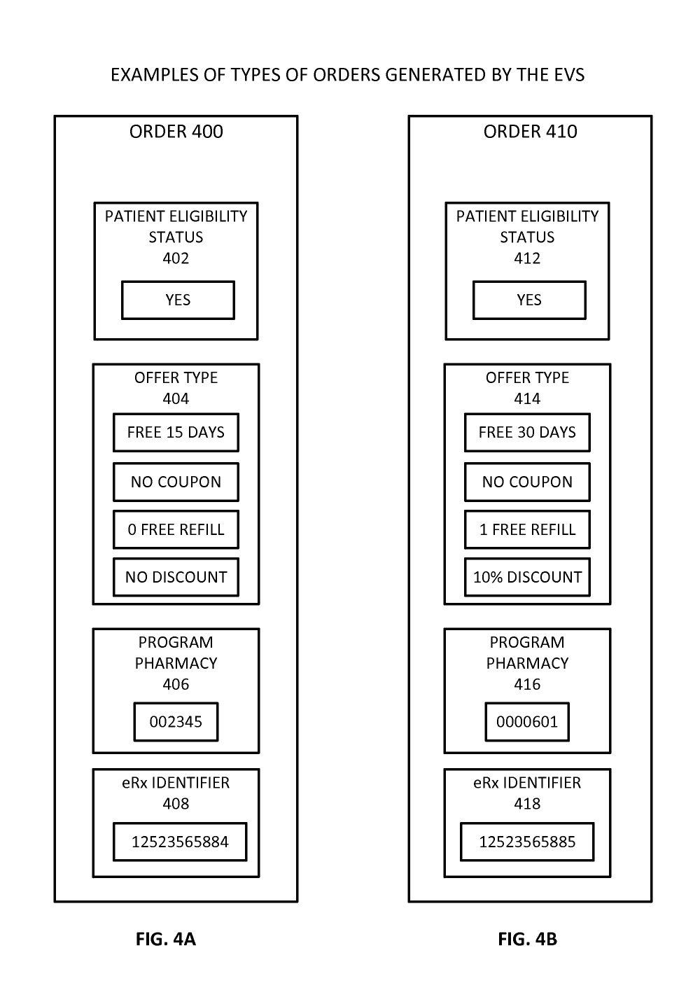

An order generator module 124 contains program instructions that, when executed by microprocessor 104, cause the microprocessor 104 to generate an order for the identified complimentary trade program. Examples of orders generated by order generator 124 are shown in FIGS. 4A and 4B. As illustrated in FIGS. 4A-4B, the order may include a patient eligibility status, offer, program pharmacy and electronic prescription (eRx) identifier.

Data Storage (Database) 137

The data storage component device 137 may comprise one or more separate data storage devices, as shown. Alternatively, data storage device 137 may be implemented in a single storage device having a plurality of files or a plurality of segmented memory tables operating under the control of a database management system (not shown), but which may be incorporated into the data storage device 137 on the EVS 100 or housed on a separate computer system (not shown). The data storage device 137 may house a complimentary trade drugs database 138 for storing data associated with the complimentary trade drug programs, an alternative drugs database 140 for storing data associated with alternative drugs which are offered in the complimentary trade drug program, a HCP database 142 for storing data associated with health care providers, and an insurance and formulary database 144 for storing data associated with insurance information, product level formulary status and industry level formulary data.

EHR Platform 146

As illustrated in FIG. 1, EHR platform 146 includes a microprocessor 152, web server 150, network interface 148, EHR platform applications 154 comprising a collection of software modules 158, 160, and 162, and a data storage device 155, which includes a patient electronic health records database 156. The patient electronic health records database stores electronic medical records for patients. Outputs, such as, for example, an electronic prescription (eRx) and patient data, may be provided to the EVS 100. Non-complimentary trade drug orders and prescriptions may be sent to a non-program Pharmacy Computer System 176 by way of a Prescription Routing System 184, and complimentary trade drug orders and prescriptions may be output to a Program Pharmacy Computer System 171 by way of Prescription Routing System 184. The network interface 148 is provided to establish a connection to the HCP computer system 164 and Prescription Routing System 184. The network interface 148 may also provide connectivity to remote terminals and remote computer systems (not shown) operated by other human users who wish to access, control and use the EHR Platform 100. The web server 150 delivers web content (including web pages) to external systems, such as, for example, the HCP computer system 164.

The EHR platform 146 can be any general purpose, programmable digital computing device including, for example, a personal computer, a programmable logic controller, a distributed control system, or other computing device. The EHR Platform 146 can include a central processing unit (CPU) or microprocessor, random access memory (RAM), non-volatile secondary storage (e.g., a hard drive, a floppy drive, and a CD-ROM drive), and network interfaces (e.g., a wired or wireless Ethernet card and a digital and/or analog input/output card). Application code, such as the code encompassed by EHR Platform applications 154, and program data can be loaded into the RAM from the non-volatile secondary storage and provided to the microprocessor 152 for execution. The microprocessor 152 can generate and store results on the data storage device 155 for subsequent access, display, output and/or transmission to and by other computer systems and computer programs.

The EHR Platform applications 154, which may comprise multiple firmware or software modules, discussed hereinafter, contain program instructions that cause the microprocessor 152 to perform a variety of specific tasks required to extract, parse, index and tag data contained in the patient electronic health records database 156. Additionally, the program instructions cause the microprocessor 152 to store data in the patient electronic health records database 156. The EHR Platform applications 154 allow a user of the HCP computer system to access the patient electronic health records database 156 to search, review and update patient health care records and/or create and upload new prescription and/or patient data.

A HCP user interface module 158 generates content for output to an output device for human users, such as a display monitor, printer, or speaker, and processes input received from a human-operated input device, such as a keyboard, pointing device or touch screen. The HCP user interface module 158 allows a health care provider logged onto HCP computer system 164 to navigate and view the records in patient electronic health records 156. The health care provider employs a set of human-operated input/output devices, such as a keyboard, mouse and monitor (not shown) connected to the HCP computer system 164, to navigate and review the information stored in the patient electronic health records database 156 via a web browser 168 or other desktop application running on the HCP computer system 164. The health care provider may also use the input devices to manipulate and/or correct the information stored in the patient electronic health records database 156. The output device 22 (e.g. monitor, printer and the like, not shown) connected to the HCP computer system 164 can provide a display or printout showing the details of a patient's electronic health record.

A patient EHR access module 160 executes program instructions that allow a user to access the patient's health record retrieved from the patient electronic health records database 156. The eRx generator application 162 receives prescription data from the HCP computer system 164 and generates an electronic prescription (eRx) for the patient in accordance with the prescription written for the patient by the health care provider.

HCP Computer System 164

As illustrated in FIG. 1, HCP Computer System 164 includes an EHR platform application 166, browser application 168 and network interface 170. The HCP Computer System 164 can be any general purpose, programmable digital computing device including, for example, a personal computer, a programmable logic controller, a distributed control system, or other computing device. The HCP computer system 164 can include a central processing unit (CPU) or microprocessor, random access memory (RAM), non-volatile secondary storage (e.g., a hard drive, a floppy drive, and a CD-ROM drive), and network interfaces (e.g., a wired or wireless Ethernet card and a digital and/or analog input/output card).

The EHR Platform application 166 on HCP Computer System 164 is a program that provides an interface to the EHR Platform applications 158, 160 and 162 on the EHR Platform 146. Browser application 168 is a software application for retrieving, presenting and traversing information resources on the World Wide Web (i.e., Internet). For example, browser application 168 allows the EHR Platform application 166 in the HCP Computer System 164 to access the EHR Platform applications 158, 160 and 162 on the EHR Platform 146 via the web (i.e., Internet). The network interface 170 is provided to establish a connection to EHR Platform 146. The network interface 170 may also provide connectivity to remote terminals and remote computer systems (not shown).

Prescription Routing System 184

Prescription Routing System 184 comprises a computer system or network configured to receive electronic prescriptions for complimentary and non-complimentary trade drugs from the EHR platform 146 and route those electronic prescriptions to the appropriate pharmacy computer system for fulfillment. The Prescription Routing System 184 connects electronic healthcare platform computer systems, pharmacy computer systems and prescription benefit manager computer systems, and permits these systems to automatically exchange electronic prescriptions and prescription information in a consistent and standardized way. The prescription routing network provided by SureScripts® is one example of a Prescription Routing System 184 suitable for use with certain embodiments of the present invention.

Program Pharmacy Computer System 171

As illustrated in FIG. 1, program pharmacy computer system 171 includes an ERX processing system 172 which processes incoming orders for a complimentary trade drug program and automatically sends complimentary units of the program drug to the patient. The program pharmacy computer system 171 can be any general purpose, programmable digital computing device including, for example, a personal computer, a programmable logic controller, a distributed control system, or other computing device. The program pharmacy computer system 171 can include a central processing unit (CPU) or microprocessor, random access memory (RAM), non-volatile secondary storage (e.g., a hard drive, a floppy drive, and a CD-ROM drive), and network interfaces (e.g., a wired or wireless Ethernet card and a digital and/or analog input/output card). The network interface 174 is provided to establish a connection to Prescription Routing System 184. The network interface 174 may also provide connectivity to remote terminals and remote computer systems (not shown).

Non-Program Pharmacy Computer System 176

The non-program pharmacy computer system 176 includes an ERX processing system 178 which processes incoming orders for non-complimentary trade drug orders. The non-program pharmacy computer system 176 can be any general purpose, programmable digital computing device including, for example, a personal computer, a programmable logic controller, a distributed control system, or other computing device. The non-program pharmacy computer system 176 can include a central processing unit (CPU) or microprocessor, random access memory (RAM), non-volatile secondary storage (e.g., a hard drive, a floppy drive, and a CD-ROM drive), and network interfaces (e.g., a wired or wireless Ethernet card and a digital and/or analog input/output card). The network interface 180 is provided to establish a connection to Prescription Routing System 184. The network interface 180 may also provide connectivity to remote terminals and remote computer systems (not shown).

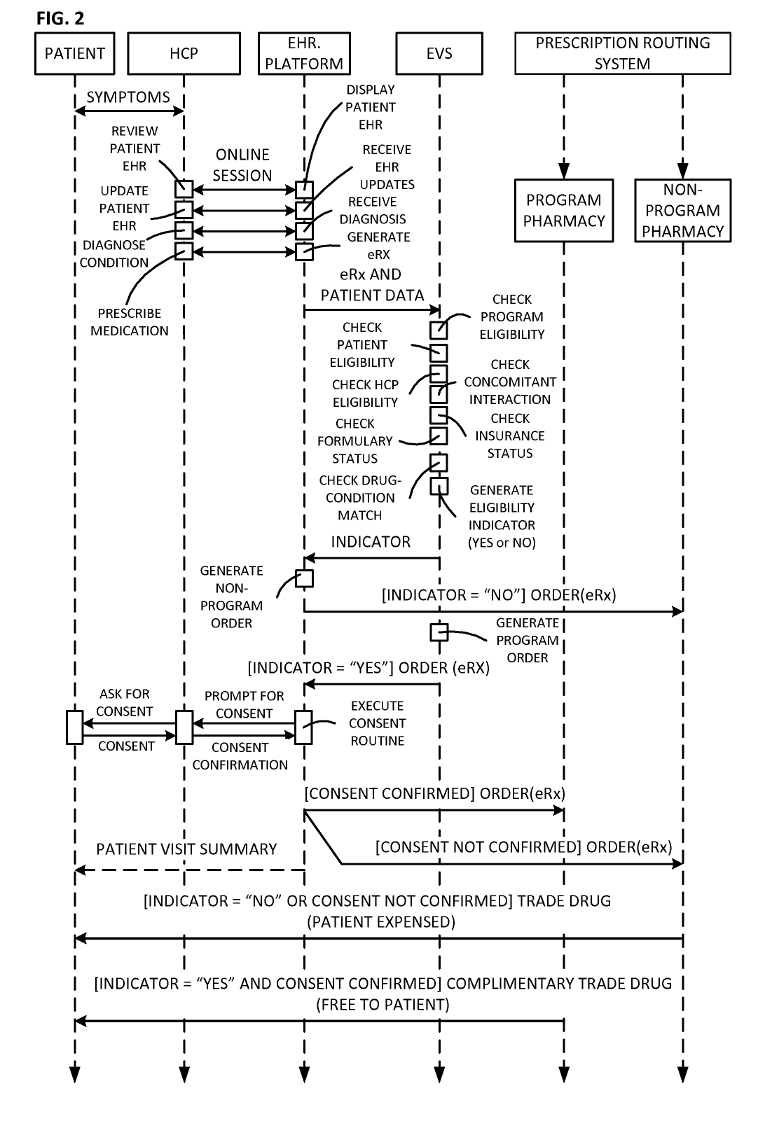

FIG. 2 illustrates the sequence of messages that may be communicated electronically among the various computer systems in the computer network of FIG. 1, such as the Prescription Routing System 184, the EHR Platform 146 and the EVS 100. The sequence commences with an interaction between the patient and the health care provider, in which the patient's symptoms are reported and assessed. Following this, the health care provider initiates an online session with the EHR Platform 146. The patient's electronic health records are accessed for review by the health care provider, who may update the records, if necessary, with any patient-, diagnosis- or prescription-related changes. These changes are then saved on the EHR Platform. The health care provider makes a diagnosis and prescribes medication, and this information is sent to the EHR Platform.

The EHR Platform 146 next transmits a message consisting of patient data and the e-Prescription (eRx) to the EVS 100, which then runs through a sequence of eligibility validation checks to determine if the prescribed drug product, the patient and the health care provider are each eligible for participation in a complimentary trade drug program. Additionally, checks are performed to determine whether the patient qualifies for an enhanced offer for the complimentary trade drug program. The EVS 100 also checks the patient's insurance status and verifies that the prescribed drug in the electronic prescription matches the patient's condition. An eligibility indicator is then generated (e.g. “YES” or “NO”), and this eligibility indicator is sent back to the EHR Platform.

An eligibility indicator of “NO” results in the EHR Platform generating a non-program (conventional) electronic prescription order and sending the non-program order to a non-program pharmacy (i.e., a pharmacy that is not participating in any complimentary trade drug program for the prescribed drug) via the Prescription Routing System 184. But an eligibility indicator of “YES” results in the EVS 100 generating a program order and sending the program order to the EHR Platform. Next, the EHR Platform prompts the health care provider to request and obtain the patient's consent. If the patient's consent is confirmed, the EHR Platform sends the eRx to a program pharmacy computer system, such as program pharmacy computer system 171 in FIG. 1, which is participating in the complimentary trade drug program. If the patient does not confirm consent, the EHR Platform sends the eRx and a non-program order to the non-program pharmacy computer system. The EHR Platform may at this point send a patient visit summary back to the patient.

If the sequence of electronic communication events results in a non-participating pharmacy dispensing the trade drug, then the patient will typically have to pay for the trade drug. However, if the sequence of electronic communication events results in a program pharmacy dispensing the trade drug, then this will typically be done at no expense to the patient. Although the diagram of FIG. 2 illustrates a particular sequence of events, those skilled in the art will recognize and appreciate that the sequence of events could be performed in a different order.

FIG. 3 shows an example of an electronic prescription (eRx) record that the EVS 100 may be configured to receive from the EHR platform over a data communications link in accordance with certain embodiments of the present invention. As shown in FIG. 3, the eRx record generated on the EHR platform by the prescriber and subsequently transmitted to and received by the EVS 100 typically includes several distinct sections, including without limitation a prescriber section containing prescriber details, a patient section containing patient details, a preferred pharmacy section containing details about the patient's preferred choice of pharmacy and a prescription section containing details about the prescription, such as the prescribed drug, quantity, formulation, days' supply, etc. Those skilled in the art will recognize and appreciate that FIG. 3 is only one non-limiting example of an eRx record that could be utilized by embodiments of the invention, and that suitable eRx records may also include a greater or fewer number of fields, as well as different field values, without departing from the scope of the present invention. It is also understood that the EVS 100 may receive a data transmission containing data representing the record itself or, alternatively, data representing an electronic pointer to a location of the eRx record in a local or remote database or other eRx record data repository. The information in the data transmission received by the EVS 100 may be encrypted or password-protected in order to ensure its integrity and preserve patient privacy in accordance with local or national health record information privacy rules and regulations.

FIGS. 4A and 4C show examples of two types of orders that may be generated by the EVS 100 and subsequently transmitted to and received by the EHR platform 146 in accordance with embodiments of the present invention. The order generated by the EVS 100 typically includes several fields, including without limitation a patient eligibility status field (402 and 412), an offer type field (404 and 414), a program pharmacy field (406 and 416), and an eRx identifier field (408 and 418). As shown in FIG. 4A, order 400 includes a patient eligibility status field 402, which has a value of “YES” to indicate that the patient is eligible for the complimentary trade drug program. In order 400, the offer type field 404 has four values, which together indicate that the patient is entitled to a free 15-day trial, no coupon, zero free refills and no price discount. The value in program pharmacy field 406 is “002345,” which is an identifier (such as a store number, for example) for the program pharmacy associated with order 400. The eRx identifier field 408 has a value of “12523565884,” which is an identifier associated with the electronic prescription.

As shown in FIG. 4B, order 410 comprises a different set of values for patient eligibility status field 412, offer type field 414, program pharmacy field 416 and eRx identifier field 418. In this case, the offer type field 414 has four values, which together indicate that the patient is entitled to a free 30-day trial, a coupon, 1 free refill and a 10% price discount. The value in program pharmacy field 416 is “0000601,” which is an identifier representing a different program pharmacy associated with order 410. The eRx identifier field 418 has a value of “12523565885.” which might be an identifier assigned to the next electronic prescription generated by the EHR platform 146.

Those skilled in the art will recognize and appreciate that FIGS. 4A and 4B constitute non-limiting examples of orders that could be generated and used by embodiments of the invention, and that suitable orders may also include a greater or fewer number of fields, as well as different field values, without departing from the scope of the present invention. Although not shown in FIGS. 4A and 4B, orders 400 and 410 would likely include, for example, order number fields to identify the orders, and EHR platform identification fields to identify the EHR platform upon which the orders were created, without departing from the scope of the invention. It is also understood that the EVS 100 may receive a data transmission containing data representing the order itself or, alternatively, data representing an electronic pointer to a location of the order in a local or remote database or other data repository. The information in the data transmission received by the EVS 100 may be encrypted or password-protected in order to ensure its integrity and preserve patient privacy in accordance with local, national or international health record information privacy rules, regulations and conventions.

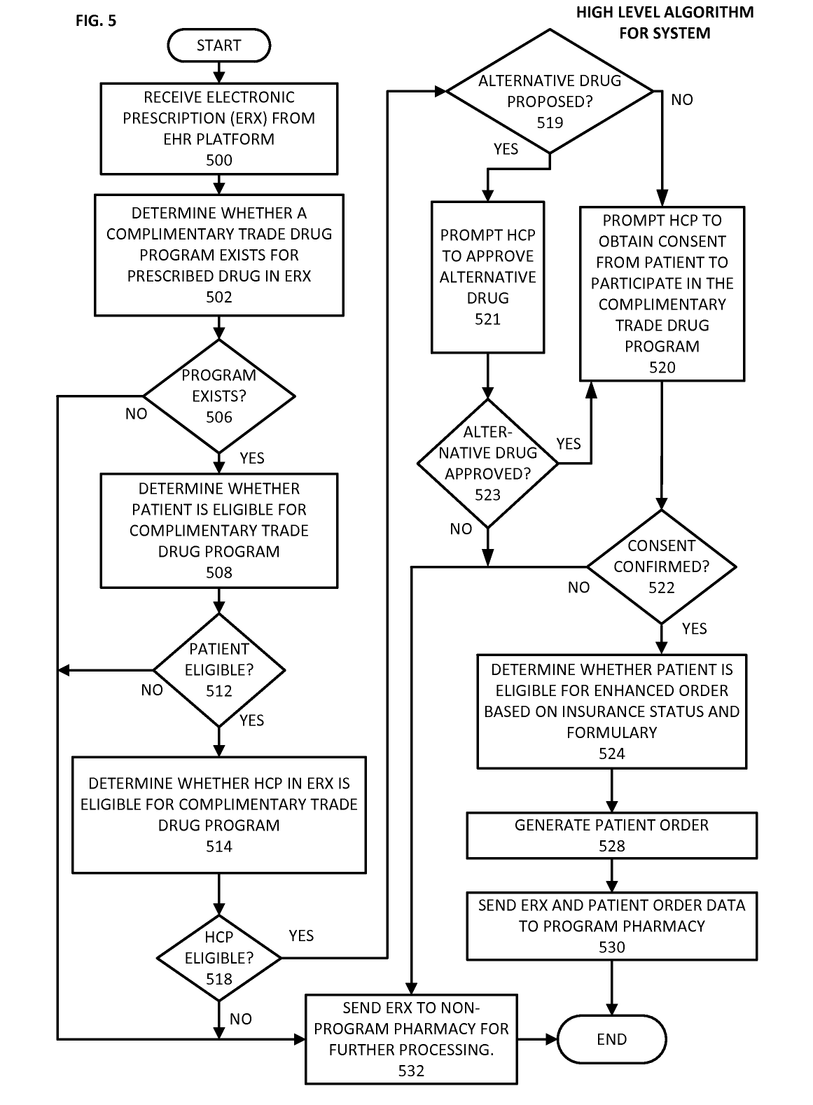

FIG. 5 shows a flow diagram illustrating, by way of example, the steps that may be performed by the collection of computer programs 108, in accordance with certain embodiments of the present invention, such as the EVS 100 shown in FIG. 1, to distribute a complimentary trade drug to a patient. The steps may be implemented via one or more computer software programs comprising a plurality of related functional modules each having program instructions for execution by the microprocessor 104 of FIG. 1, or it may be implemented by any other suitable machine or device without departing from the scope of the invention.

As illustrated in FIG. 5, the first step 500 includes receiving an electronic prescription (eRx) from EHR platform 146. Next, at steps 502 and 506, the EVS 100 determines whether a complimentary trade drug program exists for the prescribed drug in the electronic prescription using various system databases, such as, for example, a complimentary trade drug database 138 and an alternative drugs database 140. If no existing complimentary trade drug program is identified in steps 502 and 506, then the EVS 100 sends a “NO” Eligibility Indicator to the EHR platform 146 and processing continues at step 532, where the system sends the electronic prescription to a non-program pharmacy via Prescription Routing System 184 for further processing. However, if a complimentary trade drug program is identified in steps 502 and 506, then the EVS 100 determines, at steps 508 and 512, whether the patient is eligible for the identified complimentary trade drug program using system databases, such as, for example, patient health records database 156 and complimentary trade drug database 138.

If the EVS 100 determines that the patient is not eligible for the complimentary trade drug program, then the EVS sends a “NO” Eligibility Indicator to the EHR platform 146 and processing continues again at step 532, where the system sends the electronic prescription to a non-program pharmacy for further processing. But if the EVS 100 determines that the patient is in fact eligible for the identified complimentary trade drug program, then the EVS 100 next determines, at steps 514 and 518, whether the health care provider is eligible for the complimentary trade drug program (typically relying on system databases, such as, for example, HCP database 142 and complimentary trade drug database 138). If the health care provider is not eligible for the identified complimentary trade drug program, then the EVS 100 sends a “NO” Eligibility Indicator to the EHR platform 146 and processing jumps again to step 532 in order to send the electronic prescription to a non-program pharmacy by way of Prescription Routing System 184 for further processing. If the health care provider is eligible for the identified complimentary trade drug program, then the EVS 100 determines, at step 519, whether the procedure the system used to identify the existing complimentary trade drug program also involved identifying and selecting an alternative drug (i.e., any drug that is not the prescribed drug in the prescription).

If an alternative drug is not proposed, then the EVS 100 prompts the health care provider to obtain consent from the patient to participate in the complimentary trade drug program (step 520). If an alternative drug is proposed, then at step 521 the EVS 100 prompts the HCP to approve the alternative drug for use by the patient instead of the prescribed drug. At step 523, the EVS 100 determines whether the health care provider approved the alternative drug. If the health care provider approved the drug, then processing continues at step 520, wherein the EVS 100 prompts the health care provider to obtain consent from the patient to participate in the identified complimentary trade drug program. If the health care provider did not approve the alternative drug, then the EVS sends a “NO” Eligibility Indicator to the EHR platform and processing continues at step 532 (send the eRx to a non-program pharmacy for further processing via Prescription Routing System 184).

At step 522, the EVS determines whether consent was obtained from the patient to participate in the complimentary trade drug program. If the patient's consent is not confirmed, then processing continues at step 532 (eRx sent to a non-program pharmacy for further processing). If the patient's consent is confirmed, then the EVS 100 determines whether the patient is eligible for an enhanced order based on insurance status and formulary data (step 524). The EVS 100 uses system databases, such as, for example, insurance and formulary database 144 and patient health records database 156 to determine whether the patient is eligible for an enhanced offer.

At step 528, the EVS 100 generates an order, such as, for example, any one of the orders illustrated in FIGS. 4A and 4B. Next, the electronic prescription and patient order data is sent to the program pharmacy via Prescription Routing System 184 (step 530).

FIG. 6 shows a flow diagram illustrating, by way of example, the steps performed by the program eligibility checker 110 in the EVS 100, in accordance with certain embodiments of the present invention, to determine whether a complimentary trade drug program exists for the prescribed drug in the electronic prescription. At step 600, the program eligibility checker identifies the prescribed drug in the received electronic prescription. Next, at step 602 the program eligibility checker sets the search variable “target drug” equal to the prescribed drug in the electronic prescription. At steps 604 and 608, the complimentary trade drugs database 138 is searched for the target drug. If the target drug is found, then the program eligibility checker selects the complimentary trade drug program associated with the target drug at step 610 and processing returns to step 508 in FIG. 5.

The alternative drugs database 140 includes drug family information for the target drugs stored in the complimentary trade drugs database 138. If the target drug is not found in steps 604 and 608, then the program eligibility checker 110 searches the alternative drugs database 140 in order to identify an alternative drug for the prescribed drug in the electronic prescription based on the drug family for the prescribed drug (steps 612 and 616). If an alternative drug for the prescribed drug is found in the alternative drugs database 140, then the program eligibility checker 110 sets the search variable “target drug” equal to the alternative drug for the prescribed drug based on the drug family of the prescribed drug at step 618. Next, at steps 628 and 630, the complimentary trade drugs database 138 is searched once again for the “newly-assigned” target drug (which is now the alternative drug based on drug family). If the target drug is found in steps 628 and 630, then the program eligibility checker 110 selects the complimentary trade drug program associated with the target drug (step 632) and processing returns to step 508 in FIG. 5.

The alternative drugs database 140 includes diagnosis data and any associated drug(s) for treating the diagnosis. If the target drug is not found at step 630, then processing continues at step 620, where the program eligibility checker 110 identifies the diagnosis in the received electronic prescription. Notably, processing also proceeds at step 620 if the program eligibility checker 110 determines, at step 616, that an alternative drug was not found based on the drug family of the prescribed drug. In steps 622 and 624, the program eligibility checker 110 searches the alternative drugs database 140 for the diagnosis identified at step 620. If no alternative drug based on the diagnosis of the patient is found in steps 622 and 624, then the system sends the prescription to a non-program pharmacy (via the Prescription Routing System 184) for further processing (step 626). If, on the other hand, an alternative drug is found based on the patient's diagnosis, then, at step 634, the program eligibility checker 110 sets the search variable “target drug” equal to the alternative drug for the prescribed drug based on the diagnosis of the patient. Next, the target drug is searched for in the complimentary trade drugs database 138 at steps 636 and 638. If the target drug is found at steps 636 and 638, then the program eligibility checker 110 selects the complimentary trade drug program associated with the target drug (step 640) and processing returns to step 508 in FIG. 5. If the target drug is not found at steps 636 and 638, then processing continues at step 626, where the electronic prescription is sent to the non-program pharmacy (via the Prescription Routing System 184) for further processing in the conventional manner.

FIG. 7 shows a flow diagram illustrating, by way of example, the steps performed by the patient eligibility checker 112 in the EVS 100, in accordance with certain embodiments of the present invention, to determine whether the patient is eligible for the complimentary trade drug program. At steps 700 and 704, the patient eligibility checker 112 determines whether the patient is eligible for the program based on the demographic data of the patient using system databases, such as, for example, patient electronic health records database 156 and complimentary trade drugs database 138. If the patient eligibility checker 112 determines at steps 700 and 704 that the patient is not eligible for the complimentary trade drug program, then processing jumps to step 726, where the electronic prescription is sent to the Prescription Routing System 184, which sends the prescription to a non-program pharmacy for further processing in the conventional manner. If the patient eligibility checker determines that the patient is eligible for the complimentary trade drug program, then the patient eligibility checker 112 determines, at steps 706 and 710, whether the complimentary program drug is approved for the patient's condition, using system databases, such as, for example, patient health records database 156 and complimentary trade drugs database 138.

If the patient eligibility checker 112 determines at steps 706 and 710 that the complimentary program drug is not approved for the patient's condition, then processing jumps again to step 726 (prescription sent to the Prescription Routing System 184 and then to a non-program pharmacy). If the patient eligibility checker determines that the complimentary program drug is approved for the patient's condition, then the patient eligibility checker 112 determines at steps 712 and 716 whether the program drug for the complimentary program drug has any potential for adverse interactions with other drugs the patient is currently taking, using systems databases, such as, for example, patient health records database 156 and complimentary trade drugs database 138. If adverse drug interactions are identified in steps 712 and 716, then processing continues at step 726 (prescription sent to the Prescription Routing System 184 and then to a non-program pharmacy for conventional processing). But if no potential adverse drug interactions are identified in steps 712 and 716, then the patient eligibility checker 112 determines, at steps 718 and 722, whether the patient's medical history indicates any type of reaction to the class of drugs associated with the program drug in the complimentary program using systems databases, such as, for example, database 156.

If the patient's medical history indicates a previous reaction to the program drug, then processing continues at step 726 (the electronic prescription is sent to the Prescription Routing System 184 and then to a non-program pharmacy for handling in the conventional manner). If the patient's medical history does not indicate a previous reaction to the program drug, then the patient eligibility checker 112 sets the Eligibility Indicator to “Yes” and processing returns to step 514 in FIG. 5.

FIG. 8 shows a flow diagram illustrating, by way of example, the steps performed by the HCP eligibility checker 114 in the EVS 100, in accordance with certain embodiments of the present invention, to determine whether the health care provider is eligible for the complimentary trade drug program. At step 800, the HCP eligibility checker 114 determines the specialty code(s) associated with the complimentary program drug using system databases, such as, for example, complimentary trade drugs database 138. Next at step 804, the HCP eligibility checker 114 determines the specialty code of the health care provider using system databases, such as, for example, HCP database 142.

At step 808, the HCP eligibility checker 114 determines whether the health care provider's specialty code matches a specialty code authorized to prescribe the complimentary program drug. If the HCP eligibility checker 114 determines that the health care provider is authorized for the program at step 810, then the HCP eligibility checker sets the Eligibility Indicator to “YES” at step 812 and processing returns to step 519 in FIG. 5. If the HCP eligibility checker determines that the health care provider is not authorized for the program at step 810, then the electronic prescription is sent to the Prescription Routing System 184, which then routes the prescription to the non-program pharmacy 176 for further processing at step 814.

FIG. 9 shows a flow diagram illustrating, by way of example, the steps performed by insurance status checker 118 and formulary status checker 120 in the EVS 100, in accordance with certain embodiments of the present invention, to determine whether the patient is eligible to receive an enhanced offer under the complimentary trade drug program. Enhancements may include, for example, coupons, discounts and free refills. At step 900, insurance checker extracts patient-payor data from the patient health records database 156. Next at step, 904 formulary status checker determines the formulary tier for the complimentary program drug based on the patient-payor data using system databases, such as, for example, insurance and formulary data database 906.

If the formulary checker 120 determines that the patient does not qualify for an enhanced order at step 908, then formulary checker sends an indicator to the order generator 124 to generate a basic order and processing returns to step 528 in FIG. 5. If the formulary checker determines that the patient qualifies for an enhanced order, then the formulary checker sends an indicator to the order generator 124 to add one or more enhancements to the patient order data at step 910 and processing returns to the step 528 in FIG. 5.

Although FIGS. 5-9 illustrate a particular sequence of process steps, those skilled in the art will recognize and appreciate that the process steps illustrated in FIGS. 5-9 could be performed in a different order without departing from the scope of the present invention.

Although the exemplary embodiments, uses and advantages of the invention have been disclosed above with a certain degree of particularity, it will be apparent to those skilled in the art upon consideration of this specification and practice of the invention as disclosed herein that alterations and modifications can be made without departing from the spirit or the scope of the invention, which are intended to be limited only by the following claims and equivalents thereof.

What is claimed is:

1. A method of distributing a complimentary trade drug to a patient using a complimentary trade drug delivery system, the method comprising:
a) receiving on the complimentary trade drug delivery system an electronic prescription, the electronic prescription including a patient identifier and a prescribed drug;
b) identifying on the complimentary trade drug delivery system an existing complimentary trade drug program for the prescribed drug, the complimentary trade drug program including a program drug;
c) generating an order on the complimentary trade drug delivery system for the patient's participation in the complimentary trade drug program;
d) establishing on the complimentary trade drug delivery system an electronic communications channel with a prescription routing system; and
e) transmitting the order to the prescription routing system over the electronic communications channel, the order causing a program pharmacy computer system to send a complimentary unit of the program drug to the patient.

2. The method of claim 1, further comprising:
a) providing on the complimentary trade drug delivery system a set of patient eligibility rules for the identified complimentary trade drug program; and
b) determining on the complimentary trade drug delivery system that the patient is eligible for the identified complimentary trade drug program based on the set of patient eligibility rules.

3. The method of claim 1, further comprising:
a) receiving a health care provider identifier with the electronic prescription;
b) providing on the complimentary trade drug delivery system a set of health care provider eligibility rules for the identified complimentary trade drug program; and
c) determining on the complimentary trade drug delivery system that the health care provider is eligible for the identified complimentary trade drug program based on the set of health care provider eligibility rules.

4. The method of claim 1, further comprising:
determining on the complimentary trade drug delivery system that the patient is eligible to receive an enhanced offer with the identified complimentary trade drug program;

5. The method of claim 1, further comprising:
a) receiving on the complimentary trade drug delivery system a consent indicator that the patient consents to participating in the identified complimentary trade drug program for the prescribed drug.

6. The method of claim 1, further comprising:
a) receiving on the complimentary trade drug delivery system an acknowledgment from the program pharmacy computer system that the complimentary trade drug has been sent to the patient.

7. The method of claim 1, further comprising:
a) determining on the complimentary trade drug delivery system that the prescribed drug is associated with a particular drug family; and
b) identifying the existing complimentary trade drug program on the complimentary trade drug delivery system based on the association with the particular drug family.

8. The method of claim 1, further comprising:
a) receiving on the complimentary trade drug delivery system a diagnosis for the patient; and
b) identifying the existing complimentary trade drug program on the complimentary trade drug delivery system based on the diagnosis.

9. The method of claim 1, wherein the program drug is not the prescribed drug.

10. The method of claim 1, wherein the prescription routing system causes the program pharmacy computer system to send the program drug to the patient by mailing the program drug directly to an address associated with the patient.

11. A complimentary trade drug delivery system, comprising:
a) an electronic health record (EHR) platform for generating an electronic prescription, the electronic prescription including a patient identifier and a prescribed drug;
b) an eligibility verification system (“EVS”) comprising:
i) a microprocessor,
ii) a memory storage area;
iii) an identification module, in the memory storage area, having program instructions that, when executed by the microprocessor, cause the microprocessor to identify an existing complimentary trade drug program for the prescribed drug, the complimentary trade drug program including a program drug;
iv) an order generator module, in the memory storage area, having program instructions that, when executed by the microprocessor, cause the microprocessor to generate an order for the patient's participation in the identified complimentary trade drug program; and
c) an electronic communications channel for transmitting the order to a prescription routing system that causes the program drug to be delivered to the patient.

12. The complimentary trade drug delivery system of claim 11, wherein the EVS further comprises a patient eligibility module, in the memory storage area, having program instructions that, when executed by the microprocessor, cause the microprocessor to determine that the patient is eligible for the identified complimentary trade drug program.

13. The complimentary trade drug delivery system of claim 11, further comprising a second electronic communications channel for receiving a health care provider identifier, a diagnosis for the patient and a consent indicator indicating that the patient consents to the drug program for the prescribed drug.

14. The complimentary trade drug delivery system of claim 11, wherein the EVS further comprises a health care provider eligibility module, in the memory storage area, having program instructions that, when executed by the microprocessor, cause the microprocessor to determine that the health care provider is eligible for the identified complimentary trade drug program.

15. The complimentary trade drug delivery system of claim 11, wherein the EVS further comprises an insurance status and formulary module, in the memory storage area, having program instructions that, when executed by the microprocessor, cause the microprocessor to determine that the patient is eligible to receive an enhanced offer with the identified complimentary trade drug program.

16. The complimentary trade drug delivery system of claim 11, wherein the identification module further comprises program instructions that, when executed by the microprocessor, will cause the microprocessor to determine that the prescribed drug is associated with a particular drug family.

17. The complimentary trade drug delivery system of claim 16, wherein the identification module further comprises program instructions that, when executed by the microprocessor, will cause the microprocessor to identify the existing complimentary trade drug program based on the prescribed drug's association with the particular drug family.

18. The complimentary trade drug delivery system of claim 13, wherein the identification module further comprises program instructions that, when executed by the microprocessor, will cause the microprocessor to identify the existing complimentary trade drug program based on the diagnosis.

19. The complimentary trade drug delivery system of claim 12, wherein the patient eligibility module further comprises program instructions that, when executed by the microprocessor, will cause the microprocessor to determine that the patient is eligible for the identified complimentary trade drug program based on a set of patient eligibility rules.

20. The complimentary trade drug delivery system of claim 14, wherein the health care provider eligibility module further comprises program instructions that, when executed by the microprocessor, will cause the microprocessor to determine that the health care provider is eligible for the identified complimentary trade drug program based on a set of health care provider eligibility rules.

21. The complimentary trade drug delivery system of claim 11, wherein the electronic communications channel receives an acknowledgment from the program pharmacy computer system that the complimentary trade drug has been sent to the patient.

22. The complimentary trade drug delivery system of claim 11, wherein the program drug is not the prescribed drug.
